(19) United States
(12) Patent Application Publication
(10) Pub. No.: US 2004/0007522 A1
(43) Pub. Date: Jan. 15, 2004

(54) Liquid filter element

(75) Inventor: Efraim Garti, Kibbutz Yizreel (IL)

Correspondence Address: LACKENBACH SIEGEL, ONE CHASE ROAD, SCARSDALE, NY, 10583, US

(73) Assignee: MAYTRONICS LTD., Kibbutz Yizreel (IL)

(21) Appl. No.: 10/603,269

(22) Filed: Jun. 25, 2003

(30) Foreign Application Priority Data
Jul. 3, 2002 (IL) 150,567

(51) Int. Cl. B01D 35/00

(52) U.S. Cl. 210/483; 210/169; 210/452; 210/500.36

(57) ABSTRACT

The invention provides a disposable filter, including a filtering bag with an opening, the bag being made of a non-woven, synthetic material having filtering perforations, and a substantially flat, stretchable band extending along the periphery of the opening, facilitating the easy attachment and detachment of the bag within a liquid filtering apparatus.

### FIELD OF THE INVENTION

The present invention relates to a filter element; more particularly, it relates to a disposable filter for pool cleaners.

### BACKGROUND OF THE INVENTION

The filter elements used today in swimming pool cleaning devices and robots have to be cleaned periodically. The disadvantages of using these filters extend beyond those of the cleanable, reusable filters used in dust vacuum cleaners. After use, the pool cleaner filters are wet, causing the dirt to cling to the filter material and necessitating scraping, followed by rinsing and/or washing, of the filter. This tedious cleaning procedure must be repeated many times each season in order to achieve a reasonable degree of cleanliness in the pool. Obviously, people who acquire expensive pool-cleaning equipment do not wish to be bothered with its constant maintenance, not only with respect to the disassembly of the cleaner or robot, but also and even more so, with regard to the actual cleaning of the filter element, disposal of the collected dirt, washing of the filter and reassembly of the cleaner.

### DISCLOSURE OF THE INVENTION

It is thus an object of the present invention to ameliorate the above-described disadvantages of the known filter elements for pool cleaners or robots, and to provide a disposable filter element that need not be cleaned.

It is a further object of the present invention to provide a disposable filter element for pool cleaners or robots that is suitable and effective for use in three or more consecutive cleaning cycles.

It is a still further object of the present invention to provide a filter element for pool cleaners or robots that is easily assembled in its dry state.

Accordingly, the present invention therefore provides a disposable filter, comprising a filtering bag with an opening, the bag being made of a non-woven, synthetic material having filtering perforations, and a substantially flat, stretchable band extending along the periphery of the opening, facilitating the easy attachment and detachment of the bag within a liquid filtering apparatus.

The invention further provides, in a swimming pool cleaning apparatus including a framework having a peripheral recess for supporting a filter, a disposable filter comprising a filtering bag with an opening defined by a rim, the bag being made of a non-woven, synthetic material having filtering perforations, and a substantially flat, stretchable band extending along the rim-of the opening, the band being sized to fit into the recess in a stretched state, facilitating the easy attachment and detachment of the bag on the framework.

### BRIEF DESCRIPTION OF THE DRAWINGS

The invention will now be described in connection with certain preferred embodiments with reference to the following illustrative figures, so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is an isometric view of a preferred embodiment of a framework structured to support a filter according to the present invention within a pool cleaner;

FIG. 2 is a plan view of a filter according to the present invention, and

FIG. 3 is an isometric view of the filter of the present invention in its assembled state on the framework of FIG. 1.

### DETAILED DESCRIPTION OF THE PREFERRED EMBODIMENTS

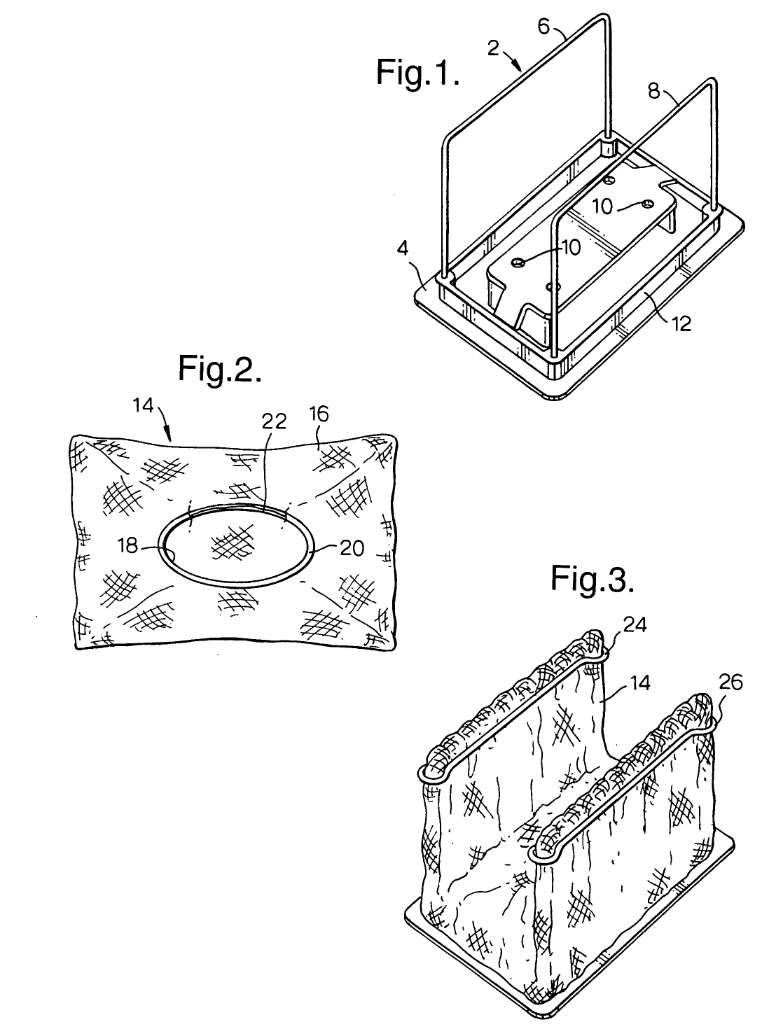

Illustrated in FIG. 1 is a portion 2 of a pool-cleaning apparatus such as a swimming pool robot, including a base 4 supporting two substantially rectangular framework members 6, 8 disposed parallel to each other. Raw liquid inlet openings 10 are made in the base. Further provided is a recessed, circumferential strip 12.

Referring now to FIG. 2, there is shown a filter 14, made of a non-woven, synthetic material 16 such as polypropylene, having perforations of a size of between 70-80 microns. Material 16 is lightweight, e.g., 51.2 g/m², has a stretching strength of 100.0 and 60.5 (length and width, respectively), and a bursting strength of about 80 lb/in². The filter is further characterized by air permeability of cm³/cm²/sec, as follows:

1 mbar-325

2 mbar-510

3 mbar-850.

Filter 14 is formed with an opening 18 having a sleeve 20 extending around its rim, through which is passed an elastic band 22. The sleeved opening 18 and elastic band 22 are sized to closely fit around and cling strongly to the recessed circumferential strip 12.

FIG. 3 illustrates filter 14 in its assembled state, slipped over framework members 6, 8 with the stretchable opening 18 tightly surrounding and clinging to recessed strip 12. In order to assure that the filter 14 will not be dislodged during use, two resilient, elongated loop clamps 24, 26 are utilized, each clamp slipping and stretching over the portion of the filter material covering member 6 or 8.

The disassembly of the filter for replacement is effected in reverse order. First, clamps 24, 26 are removed and then the entire filter 14 is removed with its opening 18 facing upwards, by dislodging the stretchable band 22 from recessed strip 12.

The non-woven, synthetic material of which the filter is made prevents frequent clogging of the filter, as the filtered-out dirt does not cling to, or get caught in, the material. Thus, the same filter may be used for, e.g., three or more filtering cycles without being replaced. Proper filtering operation is also achieved due to the high rate of air permeability of the filter material, relative to that of known prior art filters.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A disposable filter, comprising:
a filtering bag with an opening, said bag being made of a non-woven, synthetic material having filtering perforations, and
a substantially flat, stretchable band extending along the periphery of said opening, facilitating the easy attachment and detachment of said bag within a liquid filtering apparatus.

2. The filter as claimed in claim 1, wherein said filtering perforations are of a size between 70 to 80 microns.

3. The filter as claimed in claim 1, wherein said filter has an air permeability as follows:
for 1 mbar-325 cm³/cm²/sec;
for 2 mbar-510 cm³/cm²/sec, and
for 3 mbar-850 cm³/cm²/sec.

4. The filter as claimed in claim 1, wherein said filter has a stretching strength of about 100.0 length and 60.5 width, and a bursting strength of about 80 lb/in².

5. The filter as claimed in claim 1, wherein said filter is made of polypropylene having a weight of about 51.2 g/m².

6. The filter as claimed in claim 1, wherein said stretchable band is of a substantially rectangular cross-section.

7. In a swimming pool cleaning apparatus including a framework having a peripheral recess for supporting a filter, the improvement comprising:
a disposable filter;
a filtering bag with an opening defined by a rim, said bag being made of a nonwoven, woven, synthetic material having filtering perforations, and
a substantially flat, stretchable band extending along said rim of the opening, the band being sized to fit into said recess in a stretched state, facilitating the easy attachment and detachment of the bag on said framework.

8. In the swimming pool as claimed in claim 7, wherein said filtering perforations are of a size between 70 to 80 microns.

9. In the swimming pool as claimed in claim 7, wherein said filter has an air permeability as follows:
for 1 mbar-325 cm³/cm²/sec;
for 2 mbar-510 cm³/cm²/sec, and
for 3 mbar-850 cm³/cm²/sec.

10. In the swimming pool as claimed in claim 7, wherein said filter has a stretching strength of about 100.0 length and 60.5 width, and a bursting strength of about 80 lb/in².

11. In the swimming pool as claimed in claim 7, wherein said filter is made of polypropylene having a weight of about 51.2 g/m².

12. In the swimming pool as claimed in claim 7, wherein said stretchable band is of a substantially rectangular cross-section.

13. In the swimming pool as claimed in claim 7, wherein the filter in its assembled state is slipped over said framework with a stretchable opening tightly surrounding and clinging to a recessed strip.
